(19) United States
(12) Patent Application Publication
(10) Pub. No.: US 2009/0055217 A1
(43) Pub. Date: Feb. 26, 2009

(54) Method and system for identifying and communicating a health risk

(76) Inventors: Anthony J. Grichnik, Peoria, IL (US); Michael Lee Taylor, Morton, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/892,539

(22) Filed: Aug. 23, 2007

(51) Int. Cl. G06Q 50/00; G06F 17/00

(52) U.S. Cl. 705/2

(57) ABSTRACT

A method is provided for identifying and communicating a health risk to an individual. The method may include obtaining health information for an individual and predicting, based on the health information, a risk of the individual contracting a disease. The method may also include calculating a rate of change of the risk and calculating a forecasted risk based on the rate of change. Further, the method may include initiating a present action when the forecasted risk is above a first predetermined threshold at a future time.

### TECHNICAL FIELD

This disclosure relates generally to health care, and, more particularly, to methods and systems for identifying and communicating a health risk.

### BACKGROUND

The health care industry focuses on treatment and recovery from different diseases. For example, a large amount of research has been devoted to treating cancer. But even with improved treatment programs, sometimes diseases are discovered too late for treatment to be effective. Instead, patients would rather learn that they are susceptible to contracting a disease when their likelihood of preventing a disease or full recovery from a disease is greatest. Indeed, many chronic conditions, such as heart disease, diabetes, and certain forms of cancer, can sometimes be avoided if certain lifestyle modifications can be made sufficiently prior to disease onset.

One tool that has been developed for predicting disease onset is U.S. Pat. No. 7,181,375 (the '375 Patent). The '375 patent offers a method and system for determining patient states by mining information from a patient record using a domain knowledge base relating to a disease of interest. The '375 patent uses the information and a model to determine a current state and future states of a patient for different courses of treatment.

Although the tool of the '375 patent allows determining a future state of a patient, the '375 patent only attempts to identify when a patient has a high risk for contracting a disease. The '304 patent does not allow tracking of a change in risk over a period of time. Accordingly, the '304 patent only identifies when a patient has a high risk of contracting a disease, which may be too late to prevent disease onset. One would prefer a method where the risk for contracting a disease can be forecasted in the future based on a rate of change in risk.

The present disclosure is directed to overcoming one or more of the problems set forth above.

### SUMMARY OF THE INVENTION

In accordance with one aspect, the present disclosure is directed toward a computer-readable medium comprising instructions which, when executed by a processor, perform a method for identifying and communicating a health risk. The method may include obtaining health information for an individual and predicting, based on the health information, a risk of the individual contracting a disease. The method may also include calculating a rate of change of the risk and calculating a forecasted risk based on the rate of change. Further, the method may include initiating a present action when the forecasted risk is above a first predetermined threshold at a future time.

According to another aspect, the present disclosure is directed toward a method for identifying and communicating a health risk. The method may include obtaining health information for an individual and predicting, based on the health information, a risk of the individual contracting a disease. The method may also include calculating a rate of change of the risk and calculating a forecasted risk based on the rate of change. Further, the method may include initiating a present action when the forecasted risk is above a first predetermined threshold at a future time.

According to another aspect, the present disclosure is directed to a computer system including memory, at least one input device, and a central processing unit in communication with the memory and the at least one input device. The central processing unit may obtain health information for an individual and predict, based on the health information, a risk of the individual contracting a disease. The central processing unit may also calculate a rate of change of the risk and calculate a forecasted risk based on the rate of change. Further, the central processing unit may initiate a present action when the forecasted risk is above a first predetermined threshold at a future time.

### BRIEF DESCRIPTION OF THE DRAWINGS

FIG. 1 is a block illustration of an exemplary disclosed system for identifying and communicating health risks.

FIG. 2 is a flowchart illustration of an exemplary disclosed method for identifying and communicating health risks.

FIG. 3 is a schematic illustration of graphed health risks.

### DETAILED DESCRIPTION

Reference will now be made in detail to exemplary embodiments, which are illustrated in the accompanying drawings. Wherever possible, the same reference numbers will be used throughout the drawings to refer to the same or like parts.

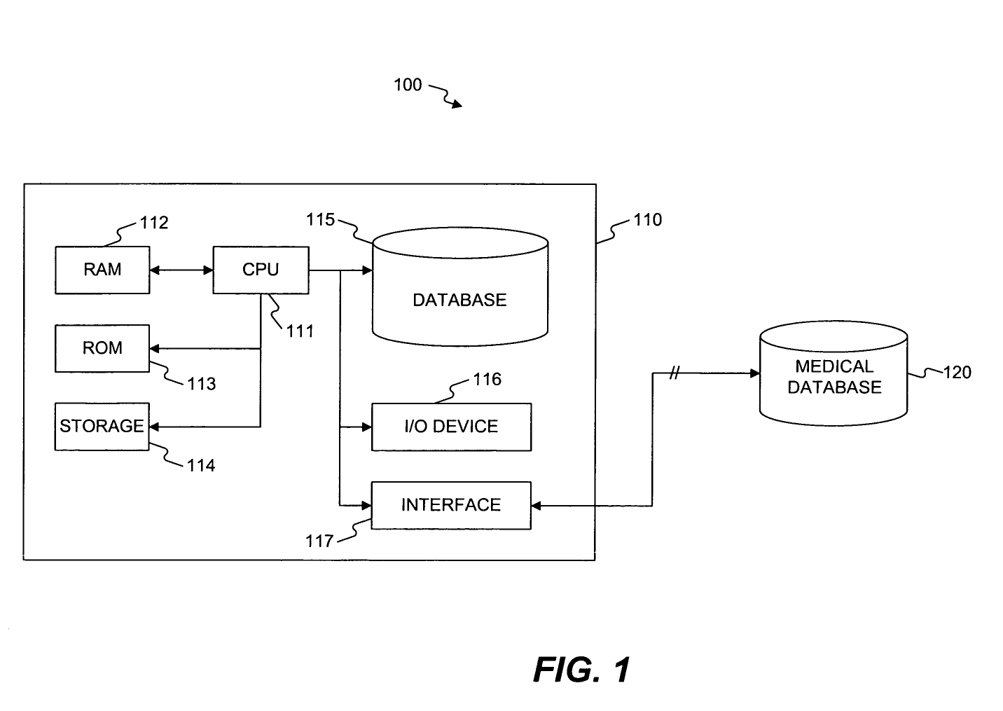

FIG. 1 provides a block diagram illustrating an exemplary environment 100 for identifying and communicating health risks. Environment 100 may include a system 110 and a medical database 120. System 110 may be, for example, a general purpose personal computer or a server. Although illustrated as a single system 110, a plurality of systems 110 may connect to other systems, to a centralized server, or to a plurality of distributed servers using, for example, wired or wireless communication.

System 110 may include any type of processor-based system on which processes and methods consistent with the disclosed embodiments may be implemented. For example, as illustrated in FIG. 1, system 110 may include one or more hardware and/or software components configured to execute software programs. System 110 may include one or more hardware components such as a central processing unit (CPU) 111, a random access memory (RAM) module 112, a read-only memory (ROM) module 113, a storage 114, a database 115, one or more input/output (I/O) devices 116, and an interface 117. System 110 may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system 110, including information for identifying and communicating health risks to an individual.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and CPU 111. Database 115 may store data collected by system 110 to monitor individual's health, identify health risks, and communicate health risks to the individual.

I/O device 116 may include one or more components configured to communicate information to a user associated with system 110. For example, I/O devices may include a console with an integrated keyboard and mouse to allow a user to input parameters associated with system 110. I/O device 116 may also include a display, such as a monitor, including a graphical user interface (GUI) for outputting information. I/O devices 116 may also include peripheral devices such as, for example, a printer for printing information and reports associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

The results of received data may be provided as an output from system 110 to I/O device 116 for printed display, viewing, and/or further communication to other system devices. Output from system 110 may also be provided to database 115 and to medical database 120.

Interface 117 may include one or more components configured to transmit and receive data via a communication network, such as the Internet, a local area network, a workstation peer-to-peer network, a direct link network, a wireless network, or any other suitable communication platform. In this manner, system 110 may communicate with other network devices, such as dictionary database 120, through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

Medical database 120 may store information regarding individuals that may be useful in identifying potential health risks. Exemplary information includes an individual's height, weight, blood pressure, resting pulse, x-ray results, lab test results, health history, name, ethnicity, contact information (e.g., mailing address, e-mail address, phone numbers), the individual's insurance company and doctors, and any other information that may be useful for predicting a health risk. Medical database 120 may also store one or more algorithms for predicting whether an individual will contract a disease and determining whether the individual may reduce their risk of contracting a disease by making lifestyle changes. Although several examples of health information have been provided, many other types of health information may be stored in medical database 120 as needed to predict, identify, and treat a variety of diseases.

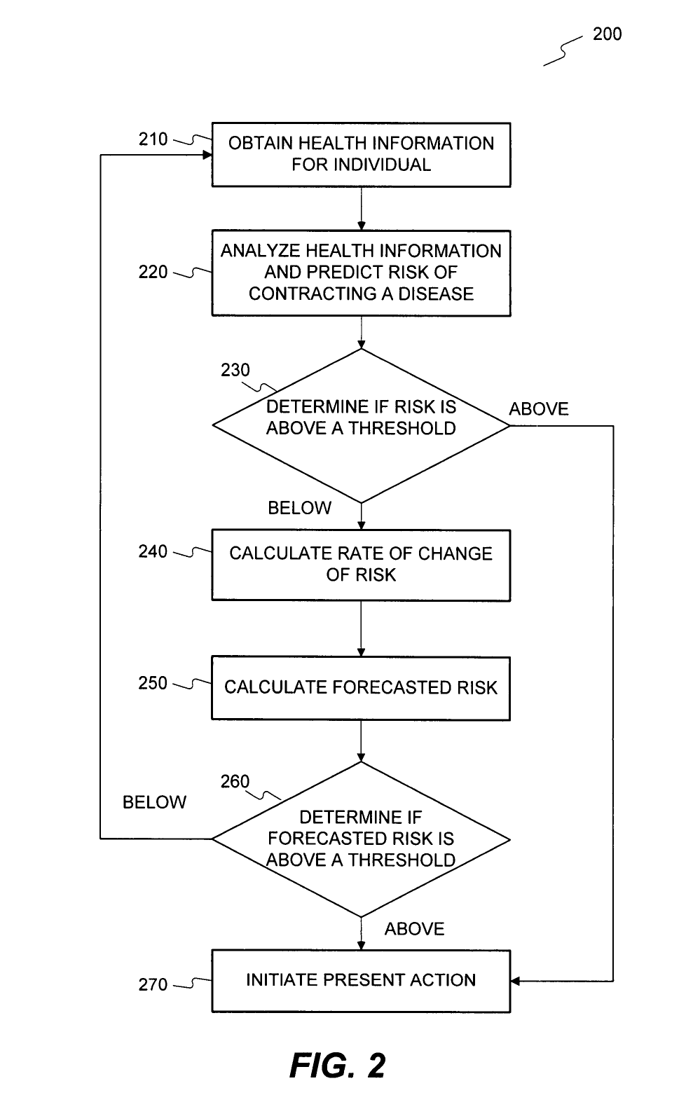

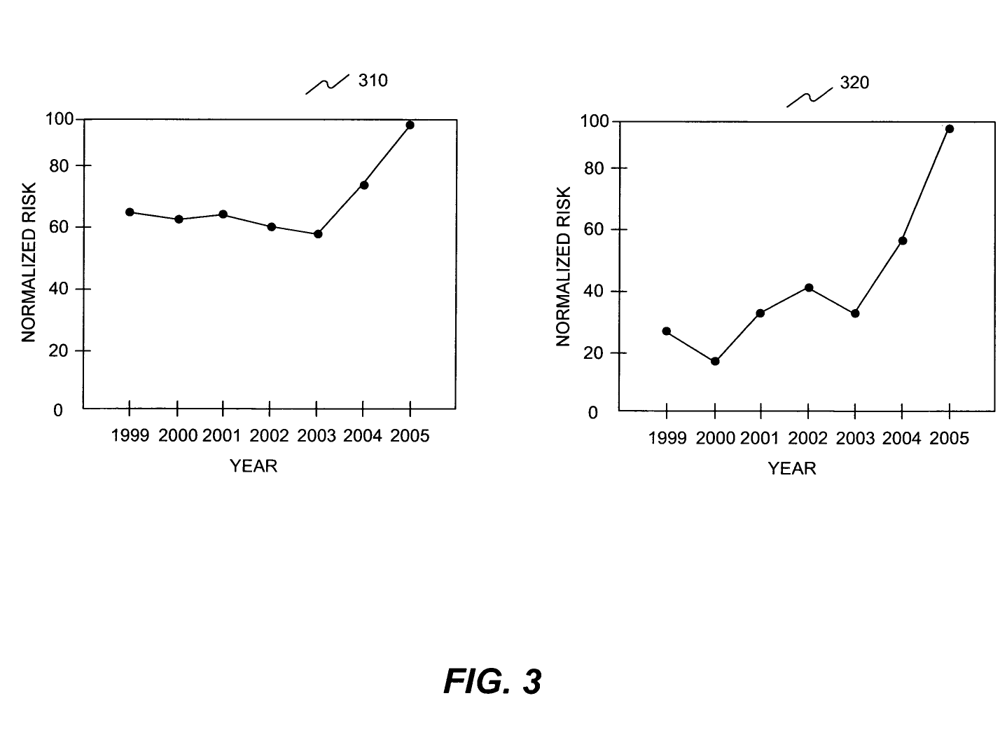

Although not illustrated, one or more servers may contain medical database 120. A server may collect data from a plurality of systems 110 to provide a central repository for identifying and communicating health risks to individuals. Moreover, medical database 120 may include one or more databases that are in the same or different location. Examples of identifying and communicating health risks will be described below with reference to FIGS. 2 and 3.

Those skilled in the art will appreciate that all or part of systems and methods consistent with the present disclosure may be stored on or read from other computer-readable media. Environment 100 may include a computer-readable medium having stored thereon machine executable instructions for performing, among other things, the methods disclosed herein. Exemplary computer readable media may include secondary storage devices, like hard disks, floppy disks, and CD-ROM; or other forms of computer-readable memory, such as read-only memory (ROM) 113 or random-access memory (RAM) 112. Such computer-readable media may be embodied by one or more components of environment 100, such as CPU 111, storage 113, database 115, medical database 120.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (ASIC) that are custom designed for this purpose.

The described implementation may include a particular network configuration, but embodiments of the present disclosure may be implemented in a variety of data communication network environments using software, hardware, or a combination of hardware and software to provide the processing functions.

Processes and methods consistent with the disclosed embodiments may identify and communicate health risks. System 110 may identify individuals who are likely to contract a disease prior to their risk for obtaining a disease reaching a predetermined threshold. System 110 may communicate health risks to individuals based on how severe a risk is for contracting a disease. As a result, individuals may be notified of a risk for contracting a disease prior to disease onset, allowing the individual to make preventative changes, reduce their risk of contracting a disease, and reduce health care costs.

Exemplary processes, methods, and user interfaces consistent with the invention will now be described with reference to FIGS. 2 and 3.

### INDUSTRIAL APPLICABILITY

The disclosed methods and systems provide a desired solution for identifying and communicating health risks. Individuals can track the likelihood of contracting a disease and make lifestyle changes while the likelihood of preventing or effectively treating a disease is great. Companies can track the health of their employees and notify them of health risks, reducing the cost of health care and allowing employees to continue working. Accordingly, environment 100 may allow detection and communication of health risks in a manner that increases the possibility of survival from a disease and reduces health care costs.

FIG. 2 is a flowchart illustration of an exemplary disclosed method 200 for identifying and communicating health risks. System 110 may perform method 200 periodically (e.g., every month), on demand, continuously, or at a triggering event, such as when a patient visits a doctor. System 110 may be run by, for example, a company or a health insurance company to identify and communicate health risks to employees and insured individuals. Doctors and medical students may also use method 200 to study changing health risks for a sample population. System 110 may predict the risk of any disease, such as various forms of cancer, heart disease, diabetes, cardiovascular disease, and other diseases.

Method 200 may begin with system 110 obtaining health information for an individual (Step 210). System 110 may gather health information from, for example, doctors that an individual visits, insurance companies that an individual uses, an individual through the use of one or more web-based forms, a company upon initial hiring of an individual (e.g., performing a physical or drug test), or any other source. System 110 may store the health information in, for example, database 115 and medical database 120. Individuals may also identify the amount of health information that system 110 can collect, allowing an individual to maintain their privacy.

Next, system 110 may analyze the health information and predict a risk of contracting a disease (Step 220). System 110 may analyze the risk of all diseases or only those disease that the individual is likely to contract based on the collected health information. System 110 may predict the risk of an individual contracting the selected diseases using one or more developed models. For example, system 110 may predict an individual's risk of heart disease or stroke based on the Framingham Heart Study. Examples of health information for the Framingham Heart Study may include an individual's age, gender, systolic blood pressure, whether the individual smokes, whether the individual has any significant heart murmurs, and other health history, such as prior heart failures. Other forecasting models may also be used, such as an autoregressive integrated moving average model disclosed in U.S. Pat. No. 7,213,007 or the method for forecasting using a genetic algorithm disclosed in U.S. Patent Application Publication No. 2004/0139041. Moreover, multiple models may be used, and system 110 may normalize scores of the models to a standard scale, such as 0 to 100, with 100 indicating that an individual has the disease.

Further, system 110 may determine if the risk is above a threshold (Step 230). System 110 may establish the threshold based on the model used. For example, using the Framingham Heart Study, a normalized risk of 60 on a scale of 0 to 100 may indicate that an individual is very likely to contract heart disease. If a user is above the threshold, system 110 may contact the individual immediately (Step 270). If the individual's risk is so high that medical treatment is unlikely to be successful, the individual may not be contacted.

If, however, the risk is not above a first threshold, system 110 may calculate a rate of change of the risk. Continuing with the example above, assume that an individual has a heart disease risk factor of 25 in year one, 35 in year two, and 50 in year three. Although the individual's risk of heart disease is still below the first threshold of 60, the rate of change for the individual may be high compared to the rate of change for the general population. High rates of change may indicate that an individual may become at risk for a disease in the future.

The risk of contracting a disease, such as heart disease, may increase rapidly over the course of several years as the individual's health information changes. For example, if an individual starts smoking, becomes obese, or develops another disease that can lead to heart disease, system 110 may identify a high rate of change of a risk of contracting heart disease. Although this example uses three years of data samples, system 110 may require more years of health information, such as five years, to ensure accurate prediction. Some diseases, however, may develop rapidly and may be predicted using a shorter time period, such as only several months. If the rate of change of risk is sufficiently high (e.g., a risk increasing by 10% or more per year), system 110 may contact the individual to warn them of the health risk.

Next, system 110 may calculate a forecasted risk for the individual. Risk may be forecasted using one or more models, such as the models described above, or using a straight line method to calculate a slope or rate of change for the risk. A straight line method may connect several data points in a series to identify a slope in the rate of change and forecast risk. Many other well-known methods are also available for determining a rate of change between data points and predicting the next data point in a set.

System 110 may then determine if the forecasted risk is above another threshold (Step 260). The threshold of Step 260 may be equal to or less than the threshold of Step 230 depending on the type and severity of disease being analyzed. For example, if an individual has a high risk for contracting heart disease when their normalized risk equals 60, the threshold for a forecasted risk may be 50. The threshold of Step 260 may also be a rate of change of the risk for contracting a disease. Having a lower threshold for forecasted risk may allow system 110 to contact the individuals so that the individuals can seek preventative treatment before having a high risk for contracting the disease. System 110 may predict the forecasted risk for any duration depending on the amount of health information available. For example, if the individual's parents both contract heart disease, the individual's long-term forecasted risk of contracting health disease may increase even though the individual may be healthy and have a low risk of contracting heart disease.

If the forecasted risk is above the threshold, system 110 may initiate a present action (Step 270). For example, system 110 may contact the individual. System 110 may use any type of communication to contact the individual, such as e-mail, telephone call, personal visit by a company physician, or personal visit by an outside physician or nurse. Individuals who have a higher forecasted risk may be contacted before individuals with lower forecasted risks. Moreover, individuals with a high forecasted risk and/or individuals at risk for contracting a serious or deadly illness may be personally contacted. For example, a company may send a doctor to visit an individual with a high risk of having a heart attack within the next six months, whereas the company may mail a letter to an individual with a moderate risk of developing diabetes in several years.

If the forecasted risk is below the threshold of Step 260, the individual is neither currently at high risk for contracting a disease (Step 230) nor forecasted to become high risk (Step 260). Stated otherwise, the individual is healthy with respect to the disease being predicted. System 110 may continue to monitor the individual and obtain health information (Step 210) to detect if the individual's risk of contracting a disease increases. System 110 may establish a third predetermined threshold at which to monitor a healthy individual for changing health risks. Continuing with the example above, a third predetermined threshold may be 20 for contracting heart disease. If an individual has a risk of contracting heart disease that is below 20 or if the individual's rate of change of contracting heart disease is low (e.g., below 1%), system 110 may not monitor the individual or may monitor the individual at increased intervals (e.g., annually rather than quarterly). In this manner, system 110 may reduce the computational burdens of monitoring individuals who are healthy and not likely to become significantly at risk for contracting a disease.

FIG. 3 is a schematic illustration of exemplary graphed health risks. Assume that graphs 310 and 320 indicate the likelihood of two different individuals contracting cardiovascular disease using a normalized scale of 0 to 100. Further assume that an individual has a high risk for contracting heart disease when their normalized risk is 60 or greater. Graph 310 indicates an individual who on average from 1999 through 2005, and in every year except 2003, has a normalized risk of 60 or greater. System 110 may identify this individual as being above a first threshold, 60, and contact the individual to communicate the risk (FIG. 2, Steps 230 and 270).

Graph 320 indicates an individual who in the years 1999 through 2004 has a risk of less than 60. Therefore, this individual would not be identified as having a risk above a predetermined threshold (Step 230). However, the rate of change in risk from year 2000 through year 2004 is large: the normalized risk has increased from approximately 17 to 57. System 110 may identify this rate of change as high compared to, for example, the general population, or a subset of individuals with similar information to the individual (e.g., same sex, age range, and body mass index range). As a result, the forecasted risk may indicate that the individual will be at high risk for cardiovascular disease in year 2005. Indeed, as the graph illustrates, the individual did become high risk for contracting cardiovascular disease in year 2005. By contacting the individual in advance based on the increased rate of change in the risk and/or the forecasted risk exceeding another predetermined threshold (e.g., 50 from Step 260), the individual may seek preventative treatment in 2004 to reduce the forecasted risk.

The system may be designed for medical reasons to identify and predict people who are likely to be diagnosed with a disease, allowing preventative treatments or corrective actions to occur prior to disease onset. Individuals may receive targeted communications based on their risk of contracting a disease. By identifying and contacting individuals about their risk for disease, individuals can make lifestyle changes and receive preventative treatments that may delay or eliminate their risk for contracting a disease. Examples of lifestyle changes include losing weight, stopping smoking, reducing salt intake, and exercising, although other lifestyle changes may reduce a risk of contracting a disease.

It will be apparent to those skilled in the art that various modifications and variations may be made to the disclosed methods. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for identifying and communicating a health risk, comprising:
obtaining health information for an individual;
predicting, based on the health information, a risk of the individual contracting a disease;
calculating a rate of change of the risk;
calculating a forecasted risk based on the rate of change;
initiating a present action when the forecasted risk is above a first predetermined threshold at a future time.

2. The method of claim 1, wherein the rate of change of the risk is calculated when the risk is below a second predetermined threshold.

3. The method of claim 1, further including contacting the individual when the risk is above the first predetermined threshold.

4. The method of claim 1, further including:
determining when the rate of change exceeds a sample rate of change of contracting a disease for a sample of individuals.

5. The method of claim 1, wherein predicting includes using one or more models to predict the risk.

6. The method of claim 1, further including monitoring the health information when the risk is below the first predetermined threshold and is above a third predetermined threshold.

7. The method of claim 1, wherein the forecasted risk indicates a likelihood that the individual will contract the disease.

8. A computer-readable medium comprising program instructions which, when executed by a processor, perform a method for identifying and communicating a health risk, the method comprising:
obtaining health information for an individual;
predicting, based on the health information, a risk of the individual contracting a disease;
calculating a rate of change of the risk;
calculating a forecasted risk based on the rate of change;
initiating a present action when the forecasted risk is above a first predetermined threshold at a future time.

9. The computer-readable medium of claim 8, wherein the rate of change of the risk is calculated when the risk is below a second predetermined threshold.

10. The computer-readable medium of claim 8, wherein the method further includes contacting the individual when the risk is above the first predetermined threshold.

11. The computer-readable medium of claim 8, wherein the method further includes determining when the rate of change exceeds a sample rate of change of contracting a disease for a sample of individuals.

12. The computer-readable medium of claim 11, wherein predicting includes using one or more models to predict the risk.

13. The computer-readable medium of claim 8, wherein the method further includes monitoring the health information when the risk is below the first predetermined threshold and is above a third predetermined threshold.

14. The computer-readable medium of claim 8, wherein the forecasted risk indicates a likelihood that the individual will contract the disease.

15. A system for identifying and communicating a health risk, comprising:
a memory;
at least one input device; and
at least one central processing unit in communication with the memory and the at least one input device, wherein the central processing unit:
obtains health information for an individual;
predicts, based on the health information, a risk of the individual contracting a disease;
calculates a rate of change of the risk;
calculates a forecasted risk based on the rate of change;
initiates a present action when the forecasted risk is above a first predetermined threshold at a future time.

16. The system of claim 15, wherein the rate of change of the risk is calculated when the risk is below a second predetermined threshold.

17. The system of claim 15, wherein the central processing unit contacts the individual when the risk is above the first predetermined threshold.

18. The system of claim 15, wherein:
the central processing determines when the rate of change exceeds a sample rate of change of contracting a disease for a sample of individuals; and
predicting includes using one or more models to predict the risk.

19. The system of claim 15, wherein the central processing unit monitors the health information when the risk is below the first predetermined threshold and is above a third predetermined threshold.

20. The system of claim 15, wherein the forecasted risk indicates a likelihood that the individual will contract the disease.
